(19) United States
(12) Patent Application Publication
(10) Pub. No.: US 2018/0107326 A1
(43) Pub. Date: Apr. 19, 2018

(54) Driving Method For Touch Sensitive Display Panel

(71) Applicant: Wuhan China Star Optoelectronics Technology Co., Ltd., Wuhan, Hubei (CN)

(72) Inventors: Yao-li HUANG, Shenzhen, Guangdong (CN); Xinglong HE, Shenzhen, Guangdong (US)

(73) Assignee: Wuhan China Star Optoelectronics Technology Co., Ltd., Wuhan, Hubei (CN)

(21) Appl. No.: 15/111,787

(22) PCT Filed: May 6, 2016
(86) PCT No.: PCT/CN2016/081222

§ 371 Date: Jul. 14, 2016

(30) Foreign Application Priority Data
Mar. 15, 2016 (CN) 201610145796.9

(51) Int. Cl. G06F 3/041; G02F 1/1333

(52) U.S. Cl. CPC G06F 3/0416; G02F 1/13338

(57) ABSTRACT

A driving method to a touch sensitive display panel is disclosed. The touch sensitive display panel includes a display panel for image display and a touch sensitive panel for contact detection. The driving method performs image display by the display panel while conducting contact detection by the touch sensitive panel. The driving method is capable of enhancing the display and touch sensitive performances.

### BACKGROUND OF THE INVENTION

### 1. Field of the Invention

The present disclosure relates to touch sensitive display technologies, and in particular to a driving method for a touch sensitive display panel.

### 2. The Related Arts

Conventional liquid crystal displays (LCDs) provide only display function. For a LCD with 60 Hz refresh rate, a display scan cycle (e.g., a frame time) is 16.67 ms. For a LCD of 120 Hz refresh rate, a frame time is 8.33 ms. The shorter a frame time is, the more performance demanding it is to the LCD's components. The cost of course is higher. As the conventional LCDs have only display function, the entire frame time is used to image display.

The so-called Incell LCD has contact sensors embedded inside the Incell LCD panel so that the panel is thinner and lighter. FIG. 1 is a schematic diagram showing a touch sensitive array and a pixel unit array of an existing Incell LCD panel. In order to facilitate the description of the working principle of the existing Incell LCD panel, FIG. 1 has the touch sensitive array and the pixel unit array depicted side-by-side. In reality, they are vertically stacked together. As exemplarily illustrated, the touch sensitive array includes rows A, B, C, and D, and the pixel unit array includes rows A1˜A3, B1˜B3, C1˜C3, and D1˜D3. Row A of the touch sensitive array and rows A1˜A3 of the pixel unit array are overlapped. Similarly, Row B of the touch sensitive array and rows B1˜B3 of the pixel unit array are overlapped, Row C of the touch sensitive array and rows C1˜C3 of the pixel unit array are overlapped, and so on.

As shown in FIG. 1, block electrodes are for collecting contact signals and they are connected to touch sensitive IC through conductive wires so as to deliver the collected contact signals to the touch sensitive IC. The touch sensitive IC processes and transforms the contact signals into contact location signals to central process unit (CPU). The Gate driving circuit module (Gate circuit module) sequentially turns on display driving signal lines (Gate signal lines). At any one time, only a Gate signal line is turned on, meaning corresponding rows need to be displayed. Display data provision module (Data circuit module) delivers display signals through Data signal lines. All Data signal lines are used simultaneously.

The Incell LCD panel of FIG. 1 operates as follows. Firstly, the Gate circuit module turns on the Gate signal line corresponding to row A1 (in the meantime, all other Gate signal lines are off). While the Gate signal line corresponding to row A1 is turned on, the Data circuit module delivers display signals for row A1. Then, the Gate circuit module turns on the Gate signal line corresponding to row A2 (in the meantime, all other Gate signal lines are off). While the Gate signal line corresponding to row A2 is turned on, the Data circuit module delivers display signals for row A2. Subsequently, the Gate circuit module turns on the Gate signal line corresponding to row A3 (in the meantime, all other Gate signal lines are off). While the Gate signal line corresponding to row A3 is turned on, the Data circuit module delivers display signals for row A3. Then, after the Gate signal line corresponding to row A3 is turned off, the touch sensitive IC conducts contact detection through all block electrodes simultaneously. In the meantime, all Gate signal lines are off and Data circuit module also stop delivering display signals. In other words, the Incell LCD panel stops image display. The Incell LCD panel enters a contact detection phase.

After the contact detection phase is over, the Incell LCD panel repeats the same procedure for image display on rows B1, B2, and B3. After the display on row B3 is over, the Incell LCD panel enters the contact detection phase again. The entire process is then repeated for rows C1, C2, C3, and rows D1, D2, and D3.

As described above, the existing Incell LCD panel is driven by separately conducting image display and contact detection in a time-shared manner. That is, contact detection is not conducted during the image display phase whereas image display is not conducted during the contact detection phase. In other words, driving for image display has to be stopped while conducting contact detection, and driving for contract detection has to be stopped while conducting image display. For an Incell LCD panel with 60 Hz refresh rate, within a frame time, the image display phase plus the contact detection phase is 16.67 ms, meaning the time for image display is less than 16.67 ms. Therefore, assuming all else are equal, the display performance of an Incell LCD panel would be inferior to a conventional LCD panel. If a same degree of display performance is expected, the Incell LCD panel has to adopt better components, thereby increasing the manufacturing cost. There are also existing Incell LCD panels that reserve only a very limited time (about 2 ms) for contact detection so as to reserve more time for image display, also compromising the contact detection performance.

### SUMMARY OF THE INVENTION

Therefore, the present disclosure teaches a driving method to a touch sensitive display panel that resolves the inferior image display and contact detection performance problems without incurring additional hardware cost.

The touch sensitive display panel includes a display panel for image display and a touch sensitive panel for contact detection. The driving method then performs image display by the display panel while conducting contact detection by the touch sensitive panel.

Specifically, within a display scan cycle, the entire cycle is used in image display and the same entire cycle is used in contact detection.

More specifically, while the entire display panel is controlled for image display, the entire touch sensitive panel is controlled for contact detection.

Specifically, the display panel includes a pixel unit array having a number of pixel units, and the touch sensitive panel includes a touch sensitive array having a number of block electrodes. While the entire display panel is controlled for image display, controlling the touch sensitive panel for contact detecting includes the step of sequentially turning on display driving signal lines corresponding to rows of the pixel unit array and, while the display driving signal lines are turned on, delivering display signals to the rows of the pixel unit array and, in the meantime, detecting contact along corresponding rows of the touch sensitive array.

Specifically, each row of the touch sensitive array corresponds to a number of rows of the pixel unit array.

Specifically, the touch sensitive display panel is partitioned into a number of zones. While a zone of the display panel is controlled for image display, the other zones of the touch sensitive panel are controlled for contact detection.

Specifically, the display panel includes a pixel unit array having a number of pixel units. The touch sensitive panel includes a touch sensitive array having a number of block electrodes; and a zone corresponds to a row of the touch sensitive array and to a number of rows of the pixel unit array.

The above driving method conducts contact detection while displaying images so that, within a display scan cycle, the times for image display and for contact detection, respectively, are not shortened. As such, the image display and contact detection performances of an Incell LCD panel are both guaranteed.

### BRIEF DESCRIPTION OF THE DRAWINGS

To make the technical solution of the embodiments according to the present disclosure, a brief description of the drawings that are necessary for the illustration of the embodiments will be given as follows. Apparently, the drawings described below show only example embodiments of the present disclosure and for those having ordinary skills in the art, other drawings may be easily obtained from these drawings without paying any creative effort. In the drawings:

FIG. 1 is a schematic diagram showing a touch sensitive array and a pixel unit array of an existing Incell liquid crystal display (LCD) panel.

FIG. 2 is a time sequence diagram of a conventional Incell LCD panel; and

FIG. 3 is a time sequence diagram according to an embodiment of the present disclosure.

### DETAILED DESCRIPTION OF THE PREFERRED EMBODIMENTS

Exemplary embodiments of the present disclosure are provided below so as to explain the present disclosure in details along with the accompanied drawings.

The present disclosure teach a driving method for a touch sensitive display panel which may be an Incell liquid crystal display (LCD) panel. Specifically, the touch sensitive display panel includes both a display panel for showing images and a touch sensitive panel for detecting contacts. The driving method controls the touch sensitive panel to detect contacts while controlling the display panel to show images. In other words, the driving method conducts the contact detection and image showing simultaneously. For example, within a display scan cycle, the entire period is used in showing images and the same entire period is used in detecting contacts.

FIG. 2 is a time sequence diagram of conventional Incell LCD panels.

As illustrated, existing Incell LCD panels conduct image showing and contact detection in a time-shared manner. That is, contact detection is stopped while images are shown, and image showing is stopped while contacts are detected.

FIG. 3 is a time sequence diagram according to an embodiment of the present disclosure.

As illustrated, a touch sensitive display panel according to the present disclosure conducts the contact detection and image showing simultaneously. Within a complete display scan cycle (such as a frame time), the entire period is used in showing images and the same entire period is used in detecting contacts. In this way, greater time saving is achieved, panel charging rate and touch sensitivity are both enhanced.

In the following, the driving method to the touch sensitive display panel is described along with FIG. 3.

In a first embodiment of the present disclosure, while images are displayed on the display panel, contact to the touch sensitive panel is also detected. The display panel includes a pixel unit array having multiple pixel units. The touch sensitive panel includes a touch sensitive array having multiple block electrodes. While images are displayed on the display panel, the steps of controlling the touch sensitive panel to detect contacts are as follows. Firstly, display driving signal lines corresponding to the rows of the pixel unit array are turned on sequentially and, while the display driving signal lines are turned on, display signals are delivered to the rows of the pixel unit array. In the meantime, contact is detected along the rows of the touch sensitive array. In the present embodiment, a row of the touch sensitive array corresponds to multiple rows of the pixel unit array.

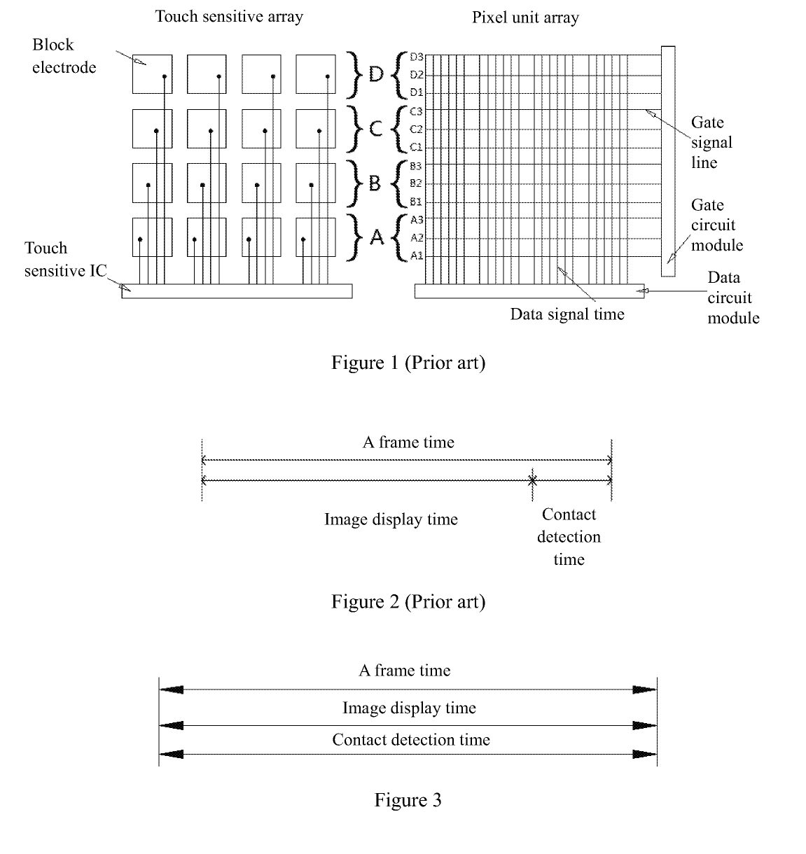

The touch sensitive display panel shown in FIG. 1 operates as follows.

As shown in FIG. 1, the Gate circuit module sequentially turns on the display driving signal lines (i.e., Gate signal lines) corresponding to rows A1/A2/A3/B1/B2/B3/C1/C2/C3/D1/D2/D3. While these display driving signal lines are turned on, the Data circuit module delivers display signals to rows A1/A2/A3/B1/B2/B3/C1/C2/C3/D1/D2/D3. In the meantime, touch sensitive IC collects touch sensitive signals from rows A, B, C, and D of the touch sensitive array.

As described above, the display process is not interrupted to collect touch sensitive signals, and there is more time for image display, thereby enhancing the display performance. Similarly, as the collection of the touch sensitive signals is not interrupted, the touch sensitive performance is also enhanced.

In a second embodiment of the present disclosure, the touch sensitive display panel is partitioned into a number of zones. While one of the zones is controlled for display, the rest of the zones are controlled for contact detection. In the present embodiment, a zone corresponds to a row of the touch sensitive array and to a number of rows of the pixel unit array.

Again, the touch sensitive display panel of FIG. 1 is used to describe the operation of the present embodiment as follows.

As illustrated, the touch sensitive array has rows A, B, C, and D, each corresponding to a zone. The zones then correspond to rows A1˜A3, B1˜B3, C1˜C3, and D1˜D3 of the pixel unit array. Row A of the touch sensitive array and rows A1˜A3 are overlapped, Row B of the touch sensitive array and rows B1˜B3 are overlapped, and so on.

Specifically, when Gate signal lines corresponding to A1/A2/A3 (i.e., a zone) is turned on by the Gate circuit module, display signals are delivered the rows A1/A2/A3 by the Data circuit module while the Gate signal lines to A1/A2/A3 are turned on. In the meantime, touch sensitive IC collects touch sensitive signals from rows B, C, and D (i.e., the other zones).

Similarly, when Gate signal lines corresponding to B1/B2/B3 (i.e., a zone) is turned on by the Gate circuit module, display signals are delivered the rows B1/B2/B3 by the Data circuit module while the Gate signal lines to B1/B2/B3 are turned on. In the meantime, touch sensitive IC collects touch sensitive signals from rows A, C, and D (i.e., the other zones).

Again, when Gate signal lines corresponding to C1/C2/C3 (i.e., a zone) is turned on by the Gate circuit module, display signals are delivered the rows C1/C2/C3 by the Data circuit module while the Gate signal lines to C1/C2/C3 are turned on. In the meantime, touch sensitive IC collects touch sensitive signals from rows A, B, and D (i.e., the other zones).

Finally, when Gate signal lines corresponding to D1/D2/D3 (i.e., a zone) is turned on by the Gate circuit module, display signals are delivered the rows D1/D2/D3 by the Data circuit module while the Gate signal lines to D1/D2/D3 are turned on. In the meantime, touch sensitive IC collects touch sensitive signals from rows A, B, and C (i.e., the other zones).

Similar to the previous embodiment, the display process is not interrupted to collect touch sensitive signals, and there is more time for image display, thereby enhancing the display performance. Similarly, as the collection of the touch sensitive signals is not interrupted, the touch sensitive performance is also enhanced.

In addition, the present embodiment has the contact detection and image display conducted simultaneously in different zones, effectively avoiding the impact to the display quality due to the crossing of the signals.

The driving method of touch sensitive display panel described above drives image display and contact detection simultaneously so that the times for image display and contact detection are not reduced, thereby guaranteeing the display and touch sensitive performances of the touch sensitive display panel.

Additionally, the above driving method of touch sensitive display panel does not require the addition of any hardware components, effectively controlling the manufacturing cost of touch sensitive display panel, and making the production of Incell LCDs of better refresh rate more achievable.

Embodiments of the present disclosure have been described, but not intending to impose any unduly constraint to the appended claims. Any modification of equivalent structure or equivalent process made according to the disclosure and drawings of the present disclosure, or any application thereof, directly or indirectly, to other related fields of technique, is considered encompassed in the scope of protection defined by the clams of the present disclosure.

What is claimed is:

1. A driving method for a touch sensitive display panel, the touch sensitive display panel comprising a display panel for image display and a touch sensitive panel for contact detection, comprising the step of:
performing image display by the display panel while conducting contact detection by the touch sensitive panel.

2. The driving method as claimed in claim 1, wherein, within a display scan cycle, the entire cycle is used in image display and the same entire cycle is used in contact detection.

3. The driving method as claimed in claim 1, wherein, while the entire display panel is controlled for image display, the entire touch sensitive panel is controlled for contact detection.

4. The driving method as claimed in claim 3, wherein the display panel comprises a pixel unit array having a plurality of pixel units; the touch sensitive panel comprising a touch sensitive array having a plurality of block electrodes; and, while the entire display panel is controlled for image display, controlling the touch sensitive panel for contact detecting comprising the step of sequentially turning on display driving signal lines corresponding to a plurality of rows of the pixel unit array and, while the display driving signal lines are turned on, delivering display signals to the rows of the pixel unit array and, in the meantime, detecting contact along corresponding rows of the touch sensitive array.

5. The driving method as claimed in claim 4, wherein each row of the touch sensitive array corresponds to a plurality of rows of the pixel unit array.

6. The driving method as claimed in claim 1, wherein the touch sensitive display panel is partitioned into a plurality of zones; and, while a zone of the display panel is controlled for image display, the other zones of the touch sensitive panel are controlled for contact detection.

7. The driving method as claimed in claim 6, wherein the display panel comprises a pixel unit array having a plurality of pixel units; the touch sensitive panel comprising a touch sensitive array having a plurality of block electrodes; and a zone corresponds to a row of the touch sensitive array and to a plurality of rows of the pixel unit array.
